(19) United States
(12) Patent Application Publication
(10) Pub. No.: US 2020/0134709 A1
(43) Pub. Date: Apr. 30, 2020

(54) SYSTEMS AND METHODS FOR ONLINE VEHICLE AUCTIONS

(71) Applicant: OnlineKars, LLC, Farmington Hills, MI (US)

(72) Inventors: Michael D. Lewison, Fresno, CA (US); Michael J. Kane, Bloomfield Hills, MI (US); Gerald D. Peck, Clovis, CA (US); Robert Thordarson, Seattle, WA (US)

(21) Appl. No.: 16/654,792

(22) Filed: Oct. 16, 2019

Related U.S. Application Data
(60) Provisional application No. 62/750,586, filed on Oct. 25, 2018.

(51) Int. Cl. G06Q 30/08

(52) U.S. Cl. CPC G06Q 30/08

(57) ABSTRACT

A method for auctioning vehicles online where bids are evaluated against auction conditions.

### RELATED APPLICATION DATA

The present invention claims the benefit of U.S. Provisional Patent Application Ser. No. 62/750,586, filed Oct. 25, 2018, titled “Systems and Methods for Online Vehicle Auctions,” the contents of which are hereby incorporated by reference as if set fully herein.

### FIELD OF THE INVENTION

The present relates generally to online auctions and more particularly to online auctions having multiple bidding options.

### BACKGROUND

When consumers are in the market for purchasing a new or used vehicle, a major concern is that the purchase price is too high or that their negotiated purchase price could have been better, thus the feeling of buyer's remorse is commonplace post purchase when buying a vehicle from an auto dealer because buyers never know if they paid a fair price. Vehicle auctions are one avenue for consumers to purchase a vehicle without the need to enter into a price negotiation and retain a sense of control and transparency in the vehicle buying process. A consumer must be savvy in order to bid smartly and would like to have flexibility and choice in the way they place bids.

On the other side, a vehicle dealership must manage vehicle inventory carefully in order to control costs and maximize profit. If, for example, a used car sits on a dealer lot for months prior to purchase, costs of capital, costs of lost opportunity, insurance costs and maintenance costs may force the dealership to reduce the sales price of the used car to a break even level or even to a level that causes the dealership to incur a loss. In order to reduce inventory, dealerships may sell vehicles at auction in order to realize profit or move inventory that is no longer profitable.

What is desired is an online vehicle auction site that provides incentives to entice consumers to utilize the auction site at a benefit to both consumer and dealership.

### SUMMARY

The present relates generally to online auctions and more particularly to online auctions having multiple bidding options.

### BRIEF DESCRIPTION OF THE DRAWINGS

FIG. 1 shows a diagram of an exemplary environment for an online auction;

FIG. 2 shows a flow diagram of an exemplary auction system that adds additional time to an auction end time;

FIG. 3 shows a flow diagram of an exemplary auction system with a countdown bidding system;

FIG. 4 shows a flow diagram of an exemplary multiple item auction system with a countdown bidding; and

FIG. 5 shows a flow diagram for an exemplary system to determine a bid by payment function for auction bidding.

### DETAILED DESCRIPTION

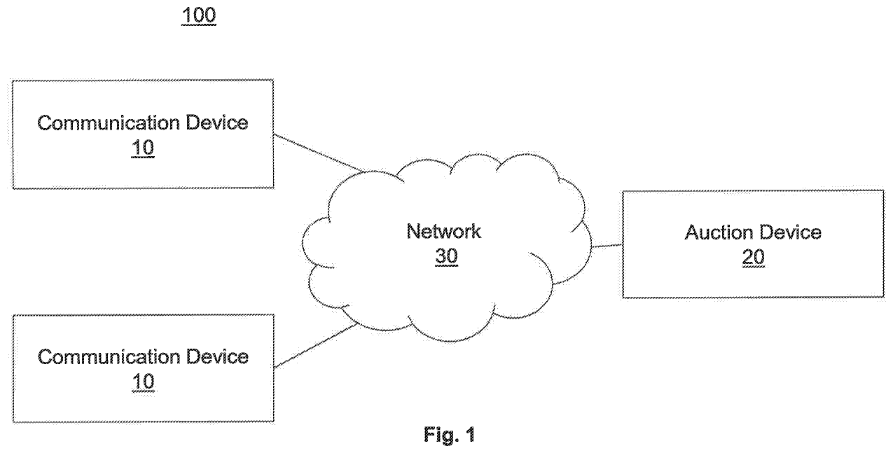

Referring to FIG. 1, a diagram of an exemplary environment for an online auction system 100 is shown. One or more communication devices, such as the communication device 10, communicate with an auction server 20 in an exemplary embodiment via a network 30. The communication device 10 may comprise a computing device, a personal digital assistant, a cellular or other smart telephone, a laptop, or the like. The network 30 may comprise any type of network, and may support any type of data communication via any standard or technology (e.g., GSM, CDMS, TDMA, WCDMA, LTE, EDGE, OFDM, GPRS, EV-DO, UWB, Internet, IEEE 802 including Ethernet, WiMAX, Bluetooth, and others). The network 30 may also be one or more private or local networks or dedicated frequency bands.

The auction server 20 may comprise any digital device, such as a server computer, a network of computers, or the like. According to an exemplary embodiment, the auction server 20 provides various network events to the communication devices 10 to enable the system of online auctions.

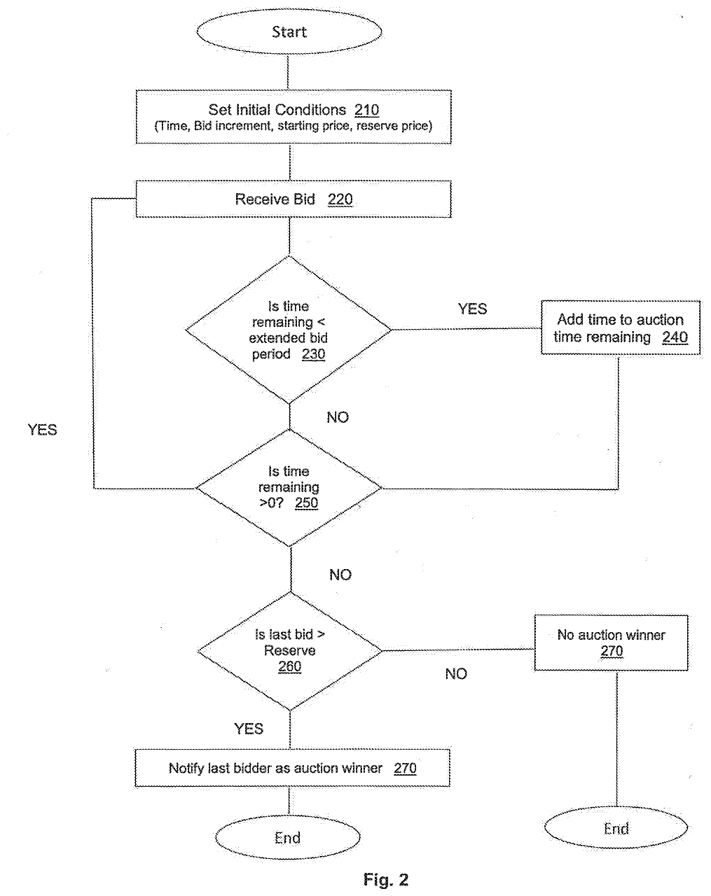

FIG. 2 is a flow diagram of an exemplary auction system 200 that adds additional time to an auction end time. At step 210, the initial conditions for the auction 200 is set by an administrator or is otherwise present by default. For example, the start and end time of the auction is set, or total auction time is otherwise set. Also, the default bid increment is set, i.e. $50 or other such desired increment. Also, a starting price for the auction and a reserve price, if desired, is set at step 210.

Once the auction begins, the auction system 200 checks to see if a bid is received. Once a bid is received, at Step 230 a time check is completed to determine if the time remaining is less than a pre-determined extended bid period. If the check in Step 230 is that there is less time remaining than the extended bid period, additional time is added to the end of the auction (i.e. 5 minutes) at Step 240 to prevent last second bidders being able to outbid in the auction.

Step 250 is a time check to see if there is any time remaining in the auction. If the system determines that there is time remaining, the system 200 waits for additional bids. Once there is no time remaining in the auction, Step 260 checks to see if the last bid is higher than the reserve amount set in Step 210. If so, the Step 270 notifies the bidders of the auction winner. Otherwise, Step 270 determines that the reserve has not been met and the auction completes with no winner.

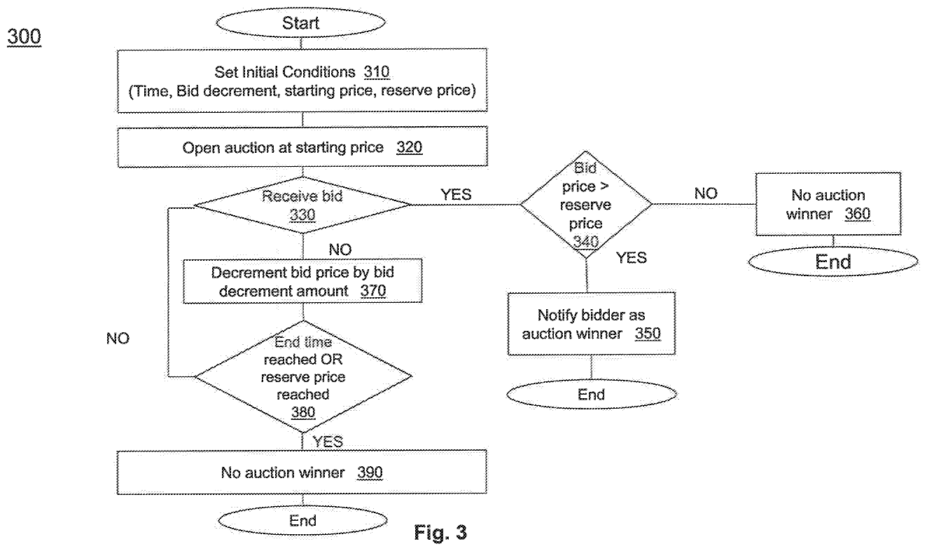

FIG. 3 shows a flow diagram of an exemplary auction system 300 with a countdown bidding system. At step 310, the initial conditions for the auction system 300 is set by an administrator or is otherwise present by default. For example, the start and end time of the auction is set, or total auction time is otherwise set. Also, the default bid increment is set, i.e. $50 or other such desired increment. Also, a starting price for the auction and a reserve price, if desired, is set at step 310.

Once the auction begins, the auction opens at the starting price at Step 320. Next, the auction system 300 checks to see if a bid is received at Step 330. In an exemplary embodiment, once a bid is received, Step 340 checks to see if the bid price is higher than the reserve price. In another exemplary embodiment, Step 340 may be optional. If so, the auction is complete and the winner is notified at Step 350 otherwise no auction winner is declared at Step 360. In another exemplary embodiment, the auction system 300 does not need to check if a bid is higher than the reserve price so Step 340 may be optional and the receipt of a bid stops the auction and the auction winner is declared.

In operation, auction system 300 may allow for each bidder to place a “best offer” and wait for the auction system 300 to reduce the bid price to match the input “best offer”.

If no bid is initially received at Step 330, the bid price is decremented at Step 370 by the preset bid decrement amount after a predetermined period of time has passed. The predetermined period of time can either be a fixed time (i.e. reduce price every five minutes or five seconds) or at a variable time as determined by some combination of number of participants and the activity of those and/or their demonstration of intention to make a transaction (i.e. reduce price after two minutes, reduce price again after 30 seconds because several participants are engaging simultaneously, or the price drop can be delayed for the same reason, etc.). A time check may be completed at Step 380 in an exemplary embodiment to check if the auction end time is met or if the reserve price has been reached, In another exemplary embodiment, the time check at Step 380 only checks if the auction end time is met. If there is time remaining or the bid price is above the reserve price, the system returns back to Step 330 to wait for a bid. If either end time or reserve price is met, the auction is determined to be complete with no auction winner at Step 390.

In an exemplary embodiment, the auction system 300 may also implement an additional time feature to generate last minute interest in an auction. At a predetermined price point above the reserve price, a determination is made as to the interest in the auction. The auction system 300 will calculate an interest value that is based upon the number of event participants and/or including interest in the event vehicle demonstrated by actions of those participants. If the interest value exceeds a predetermined metric that shows significant intent to purchase by those participants and there is an authorized additional price reduction by the seller, the auction system 300 will be extended by the amount of time needed to countdown to the new price.

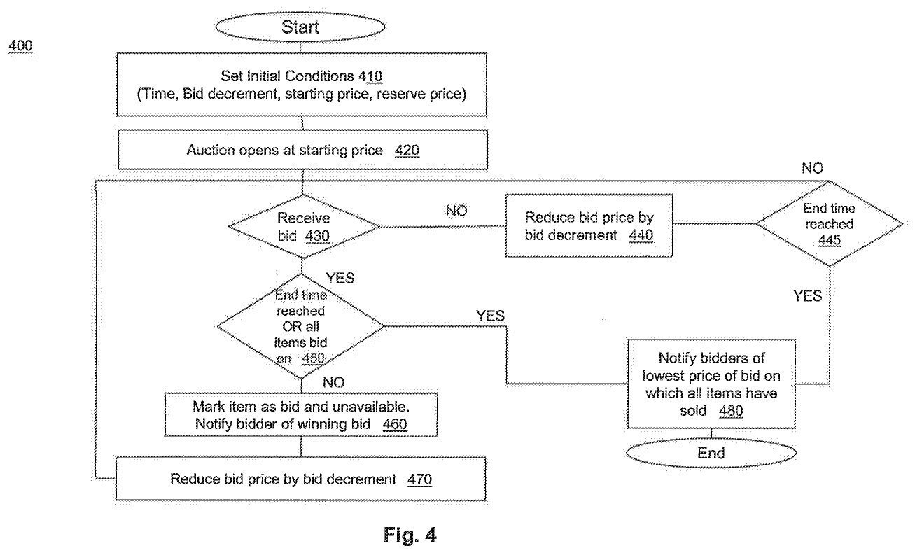

FIG. 4 shows a flow diagram of an exemplary multiple item auction system 400 with a countdown bidding. The multiple auction system 400 allows for multiple items to be bid on in a sequential order with a continuously decreasing bid price down to a reserve price. As an example, three vehicles of a similar make, model and year are enrolled in a single auction, Due to certain variations of included features, packages and/or market valuation variations for certain exterior and/or interior vehicle colors, the three vehicles may have different values. The event and the platform will enable the participants to reconcile these differences in perceived or actual value.

The event will proceed with a dropping price following the identical scenario for a single vehicle countdown-bidding event. There are two designed scenarios for setting the final bid price for each vehicle. In scenario 1, participants may select the vehicle they want when the price fall to an acceptable number. The placing of that bid selects that vehicle, and it is no longer available to the other participants. In scenario 2, the first bidder can select the vehicle of choice without determining the price. Another bidder can then select one of the remaining vehicles, again without determining a price. This would continue until only one vehicle remained, and the bid on that vehicle, which would be the lowest price in the event, would determine the price for all of the vehicles, and this would also end the event, Variations on this second scenario would change the price setting bid to be made and the event ended with a bid on one of the remaining vehicles, but not the last one. This scenario would better preserve seller margin.

At step 410, the initial conditions for the auction system 400 is set by an administrator or is otherwise present by default. For example, the start and end time of the auction is set, or total auction time is otherwise set. Also, the default time for each bid decrement is set, i.e. 30 seconds or other such desired time value in this step. Also, a starting price for the auction and a reserve price, if desired, is set at step 410.

Once the auction begins, the auction opens at the starting price at Step 420. Next, the auction system 400 checks to see if a bid is received at Step 430. If no bid is received at Step 430, the bid price is decremented at Step 440 by the preset bid decrement amount after a predetermined period of time has passed. The predetermined period of time can either be a fixed time (i.e. reduce price every five minutes) or at a random time (i.e. reduce price after two minutes, reduce price again after four minutes, etc.). A time check is completed at Step 445 in an exemplary embodiment to check if the auction end time is met or if the reserve price has been reached. If there is time remaining or the bid price is above the reserve price, the system returns back to Step 430 to wait for a bid.

Once a bid is received, Step 450 checks to see if the end time has been reached, the reserve price has been met, or if all items have been bid on. If no, the auction system 400 marks the item as bid, and the next item on the auction list is then made available for bidding in Step 460. The current bid price is then reduced in Step 470 and the system returns to Step 420 to wait for the next bid.

Step 450 determines if the end time is reached or all items have been bid on. If yes, then Step 480 notifies the winning bidders of the lowest price on which all the items in the auction have sold and the auction is complete.

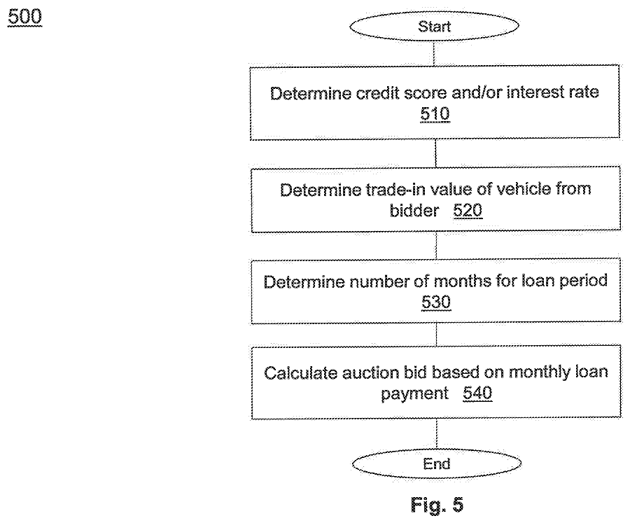

FIG. 5 shows a flow diagram for an exemplary system to determine a bid by payment system 500 for auction bidding. In an exemplary embodiment, the auction systems 200, 300, 400 can be enabled to allow a bidder to bid by a monthly payment price instead of a full payment bid. In other words, a certain credit worthiness or a bidder in conjunction with a trade-in vehicle value, and loan payment period can be input into the auction system 200, 300, 400 to allow for a bidder to bid by monthly payment price. In the bid payment system 500, Step 510 determines the credit score of a bidder. In an exemplary embodiment, the credit score of a bidder can be estimated or the actual credit score can be pulled by the auction system 200, 300, 400 to determine credit worthiness and return an initial interest rate and/or enables the bidder to enter a credit score or range, and/or the bidder is allowed to select an interest rate for use in the Bid-B Payment pricing. Next, Step 520 allows for a trade-in value to be in input to reduce the monthly payments. Further, Step 530 determines how many months that a bidder desires to set for the loan period which may reduce or increase the final monthly payments. Once the information has been entered, either an estimated or actual bid by payment is calculated. The platform can also be set with a default of showing Bid-By-Payment based upon a predetermined pricing calculation (credit/interest rate, trade-in value, additional down payment amount and loan term in months) and/or show each individual participant a customized formula based upon data about that participant which is available to the platform.

In an exemplary embodiment, the bid by payment is preset prior to an auction and the only value that changes is the monthly price based on the total value of the current auction bid price. In another exemplary embodiment, the bid by payment value may be altered by changing the number of months for the loan period which may reduce or increase the monthly payment based on how many months the loan term is for.

This disclosure is intended to explain how an auction system is constructed and used according to various embodiments in accordance with the technology rather than to limit the true, intended, and fair scope thereof. The foregoing description is not intended to be exhaustive or limited to the precise forms disclosed. Modifications or variations are possible in light of the above teachings and disclosure. The embodiments were chosen and described to provide an illustration of the principles of the described technology and its practical application, and to enable one of ordinary skill in the art to utilize the technology in various embodiments and various modifications as are suited to the particular use contemplated.

We claim:

1. A method for auctioning vehicles online comprising:
providing initial auction conditions, said initial auction conditions include auction time and bid increment;
receiving a bid;
evaluating said bid against said initial auction conditions;
determining an auction winner, wherein said auction winner exists when said bid meets said initial auction condition, wherein said auction winner is absent when said bid does not meet said initial auction condition.

2. The method of claim 1 wherein said bid is a full payment bid.

3. The method of claim 1 wherein said bid is a bid by payment bid.

4. The method of claim 1 wherein said bid is a monthly payment bid.
